(19) United States
(12) Patent Application Publication
(10) Pub. No.: US 2026/0153651 A1
(43) Pub. Date: Jun. 4, 2026

(54) WATER-REPELLENT COVER

(71) Applicants: HYUNDAI MOTOR COMPANY, SEOUL (KR); KIA CORPORATION, SEOUL (KR)

(72) Inventors: Hong Heui Lee, Hwaseong-si (KR); Byeong U Lee, Hwaseong-si (KR); Jin Young Yoon, Hwaseong-si (KR); Dong Ha Kim, Hwaseong-si (KR)

(73) Assignees: HYUNDAI MOTOR COMPANY, SEOUL (KR); KIA CORPORATION, SEOUL (KR)

(21) Appl. No.: 19/256,141

(22) Filed: Jun. 30, 2025

(30) Foreign Application Priority Data
Dec. 3, 2024 (KR) 10-2024-0176966

(51) Int. Cl. G02B 1/18; B32B 3/30; B32B 27/08; B32B 27/36; B32B 27/40

(52) U.S. Cl. CPC G02B 1/18; B32B 3/30; B32B 27/08; B32B 27/365; B32B 27/40; B32B 2250/24; B32B 2307/7265; B32B 2307/7375; B32B 2605/00

(57) ABSTRACT

Disclosed is a cover including a surface layer, wherein a surface of the surface layer includes a pattern arranged in a predetermined shape. The pattern may be made of a material same as that of the surface layer and may be integrated with the surface layer.

### CROSS REFERENCE TO RELATED APPLICATIONS

This application claims, under 35 U.S.C. §119(a), the benefit of and priority to Korean Patent Application No. 10-2024-0176966, filed on Dec. 3, 2024, the entire contents of which are incorporated herein by reference.

### TECHNICAL FIELD

The present disclosure relates to a water-repellent cover.

### BACKGROUND

A vehicle has one or more windows to secure a view outside the vehicle, a rearview mirror to secure a view behind the vehicle, or the like. In addition, an environment sensor configured to detect the surrounding environment of the vehicle is recently being mounted to the vehicle. The environment sensor may include, for example, a lidar sensor, a radar sensor, or a camera.

Precipitation such as rainwater, snow, ice, frost, and the like falling on a window may make it difficult to secure a view through the window, mirror, or environment sensor while the vehicle is moving. To attempt to address this issue, there are technologies to minimize or remove water droplets through various methods, such as mechanical or chemical methods. A mechanical method may include a wiper placed on a windshield or tailgate glass, a heating wire placed inside the mirror, or the like. A chemical method may include applying a water-repellent coating on the window, mirror, or environment sensor or attaching a film thereto.

The above information disclosed in this Background section is only for enhancement of understanding of the background of the present disclosure, and therefore it may contain information that does not form the prior art that is already known to a person of ordinary skill in the art.

### SUMMARY

The present disclosure has been made in an effort to solve the above-described problems associated with the prior art, and an object of the present disclosure is to provide a water-repellent cover that can minimize the formation of droplets of foreign substances, such as moisture, on the surface of the water-repellent cover while overcoming the weaknesses of existing technology.

Another object of the present disclosure is to provide a water-repellent cover that can easily remove moisture from the surface of the water-repellent cover while overcoming the weaknesses of existing technology.

The object of the present disclosure is not limited to the foregoing, and other objects not mentioned herein will be clearly understood by one having ordinary skill in the art to which the present disclosure pertains based on the description below.

The features of the present disclosure to achieve the object of the present disclosure as described above and to perform the characteristic functions of the present disclosure to be described later are as follows.

According to an embodiment of the present disclosure, a cover includes a surface layer, wherein a surface of the surface layer includes a pattern arranged in a predetermined shape. Here, the pattern may be made of a material same as that of the surface layer and be integrated with the surface layer.

According to an embodiment of the present disclosure, a vehicle may include the cover.

Other aspects and preferred embodiments of the present disclosure are discussed infra.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed infra.

### BRIEF DESCRIPTION OF THE FIGURES

The above and other features of the present disclosure will now be described in detail with reference to certain exemplary embodiments thereof illustrated in the accompanying drawings which are given herein below by way of illustration only, and thus are not limitative of the present disclosure, and wherein:

FIG. 1 is a cross-sectional view of a cover according to an embodiment of the present disclosure;

FIG. 2 illustrates a cover according to an embodiment of the present disclosure as viewed from S1 in FIG. 1;

FIG. 3 is an enlarged view of portion P1 in FIG. 1;

FIG. 4 illustrates a cross-sectional view of a cover according to an embodiment of the present disclosure;

FIG. 5 illustrates a side view of a vehicle;

FIG. 6 illustrates a side mirror of a vehicle including a cover according to an embodiment of the present disclosure;

FIG. 7 illustrates a housing of an environment sensor including a cover according to an embodiment of the present disclosure;

FIG. 8 is a cross-sectional view of the housing of FIG. 7; and

FIG. 9 illustrates a covering of an environment sensor including a cover according to an embodiment of the present disclosure.

It should be understood that the appended drawings are not necessarily to scale, presenting a somewhat simplified representation of various preferred features illustrative of the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

Descriptions of specific structures or functions presented in the embodiments of the present disclosure are merely exemplary for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

Meanwhile, in the present disclosure, terms such as “first” and/or “second” may be used to describe various components, but the components are not limited by the terms. These terms are only used to distinguish one component from another. For example, a first component could be termed a second component, and similarly, a second component could be termed a first component, without departing from the scope of exemplary embodiments of the present disclosure.

It will be understood that, when a component is referred to as being “connected to” or “brought into contact with” another component, the component may be directly connected to or brought into contact with the other component, or intervening components may also be present. In contrast, when a component is referred to as being “directly connected to” or “brought into direct contact with” another component, there is no intervening component present. Other terms used to describe relationships between components should be interpreted in a like fashion (e.g., “between” versus “directly between,” “adjacent” versus “directly adjacent,” etc.).

Throughout the specification, like reference numerals indicate like components. The terminology used herein is for the purpose of illustrating embodiments and is not intended to limit the present disclosure. In this specification, the singular form includes the plural sense, unless specified otherwise. The terms “comprises” and/or “comprising” used in this specification mean that the cited component, step, operation, and/or element does not exclude the presence or addition of one or more of other components, steps, operations, and/or elements.

Hereinafter, the present disclosure is described in detail with reference to the accompanying drawings.

A cover 100 according to the present disclosure may include a structure configured to minimize the formation of foreign substances, such as water droplets. In one implementation, the cover 100 may be supported by an object 102. In another implementation, the cover 100 may define at least a portion of the object 102. In one implementation, the cover 100 may be placed to protect the object 102. The cover 100 may be attached to the object 102 made of plastic or glass or may be arranged to be spaced apart from the object 102. As a non-limiting example, the object 102 may be a mirror (SM) of a vehicle V, a housing 12 of an environment sensor 2, or a covering 22 of an environment sensor 2.

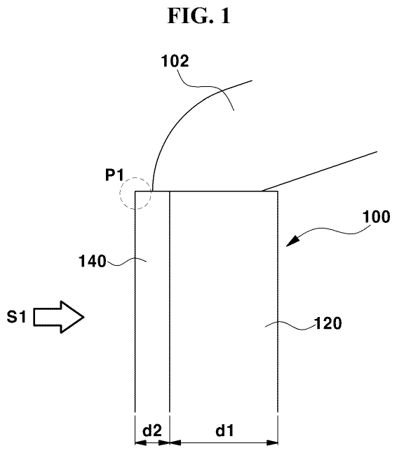

As illustrated in FIG. 1, the cover 100 may include a base layer 120 and a surface layer 140. According to one implementation, the base layer 120 and the surface layer 140 may be made of a transparent material. In some implementations, the surface layer 140 may be made of polyurethane (PU), and the base layer 120 may be made of polycarbonate (PC). In one example, the surface layer 140 may be polyurethane (PUR) or polyurea (PUA).

The base layer 120 and the surface layer 140 may be made through injection molding. According to an implementation of the present disclosure, the base layer 120 and the surface layer 140 may be integrated with each other through double-injection molding.

According to one implementation, the base layer 120 may have a thickness d1 of about 2.5 to 3.0 mm. In one implementation, the surface layer 140 may have a thickness d2 of about 0.5 to 1.0 mm. The surface layer 140 may have a thickness with which self-healing is possible.

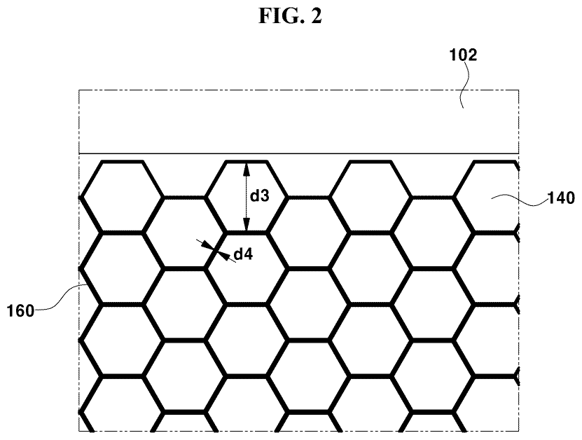

As illustrated in FIG. 2, the surface layer 140 is configured to minimize the formation of water droplets and the like and to easily remove moisture from the surface of the surface layer 140. The surface layer 140 may minimize stains formed not only by water droplets but also by other contaminants. According to an implementation of the present disclosure, the surface layer 140 includes a pattern 160. The pattern 160 may be formed on a surface of the surface layer 140. In one implementation, the pattern 160 may be formed on at least a portion of the surface layer 140.

The pattern 160 may have a predetermined shape and be arranged on the surface of the surface layer 140. As in the illustrated implementation, the pattern 160 may have a hexagonal shape and be regularly or repeatedly arranged on the surface layer 140. For example, the pattern 160 may include a regular repeat hexagonal shape. It was confirmed that a pattern including a hexagonal shape may provide greater water repellency than patterns in other shapes.

In one implementation, the pattern 160 may have a length and thickness with which the pattern 160 is not visible with naked eyes. The pattern 160 may have a length d3 and a thickness d4, with which light reflection and blurring may be minimized. In one implementation, the length d3 of the pattern 160 may be in a range of about 0.2 millimeters (mm) to 0.3 mm. In one implementation, the thickness d4 of the pattern 160 may be in a range of about 0.01 mm to 0.02 mm.

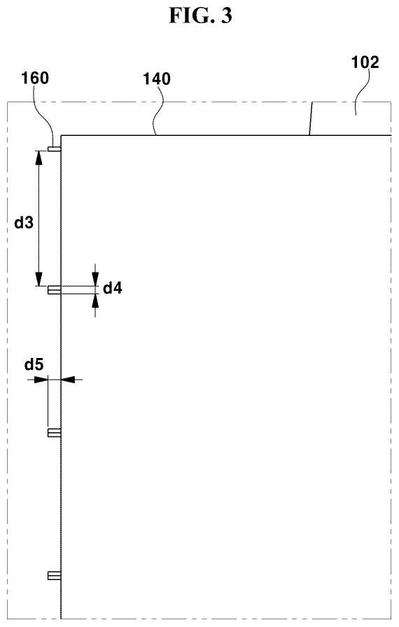

As illustrated in FIG. 3, the pattern 160 may protrude from the surface of the surface layer 140. The protruding pattern 160 may not be visible with naked eyes. For example, the protrusion height d5 of the pattern 160 may be in a range of 0.01 mm to 0.02 mm.

The pattern 160 may be integrated with the surface layer 140. In one implementation, the pattern 160 may be formed during injection molding of the surface layer 140. The pattern 160 may be integrated with the surface layer 140 using a mold including the pattern 160. Because the pattern 160 is formed through injection molding of the surface layer 140 made of PU, the pattern 160 has excellent weather resistance and reliability against ultraviolet rays of the sun and may avoid yellowing. The PU injection is a method of injecting a hardener in a liquid solvent and thus exhibits excellent dimensional stability.

The surface layer 140 may be made of a material capable of self-healing. Specifically, when damage, such as a scratch, occurs on the surface layer 140 made of PU, self-healing may be possible when the surface layer 140 is exposed to a predetermined temperature, e.g., about 70 degrees Celsius, for a predetermined time, e.g., about 3 minutes. Therefore, the cover 100 according to the present disclosure may have self-healing function owing to the surface layer 140.

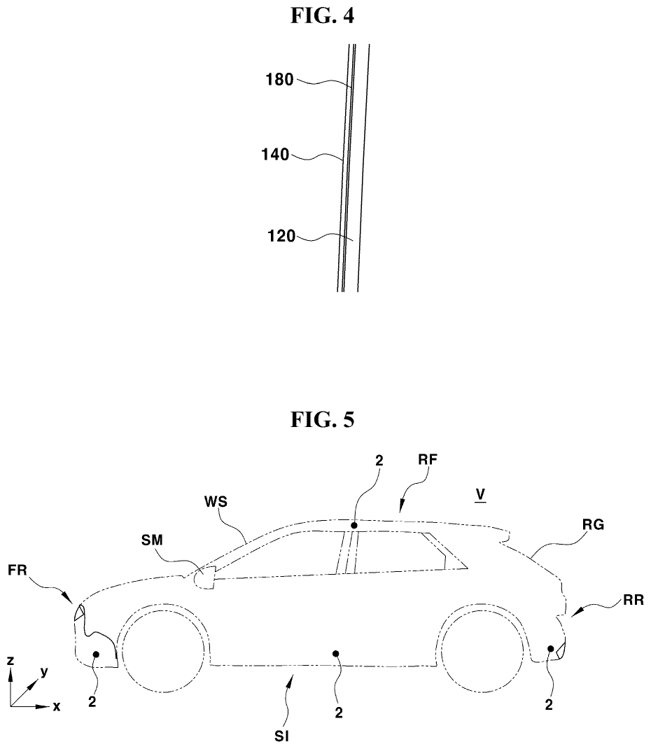

Referring to FIG. 4, the cover 100 may further include a heating film 180. The heating film 180 may be disposed between the base layer 120 and the surface layer 140. The heating film 180 is configured to generate heat by being connected to a power source. For example, the heating film 180 may include a heating wire. The heating film 180 may be configured to generate heat under a low-temperature condition or under a predetermined condition. The heating film 180 may improve defog or de-ice performance of the cover 100 including the pattern 160.

In some implementations, when the cover 100 includes the heating film 180, the heating film 180 is attached to the surface of the base layer 120 after the base layer 120 is injection-molded. The cover 100 may be manufactured by double-injecting the surface layer 140 onto the surface of the base layer 120 to which the heating film 180 is attached.

As illustrated in FIG. 5, the cover 100 may be placed on the vehicle V. For example, the cover 100 may be placed on windows, such as a windshield (WS), a rear glass (RG), or the like of the vehicle V. In some implementations, the cover 100 may be placed on an exterior mirror, such as the side mirror (SM). In some implementations, the cover 100 may be configured to protect the environment sensor 2. The environment sensor 2 may include a lidar sensor, a radar sensor, or a camera. The environment sensor 2 may be placed throughout the vehicle V, such as the front (FR), rear (RR), roof (RF), or sides (SI) of the vehicle V. In one embodiment, the cover 100 may define at least a portion of the housing 12 or covering 22 of the environment sensor 2.

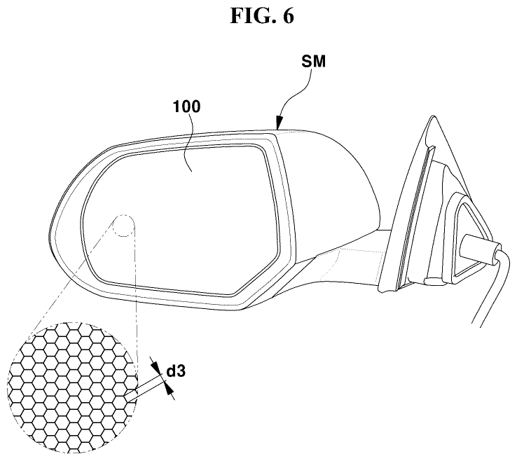

As illustrated in FIG. 6, the cover 100 may be placed on at least a portion of the mirror. For example, the cover 100 may be placed on the surface of the side mirror (SM). In some embodiments, the cover 100 including the pattern 160 may be placed to cover the side mirror (SM) while being spaced apart from the side mirror (SM). In some embodiments, the cover 100 including the pattern 160 may be attached to the side mirror (SM).

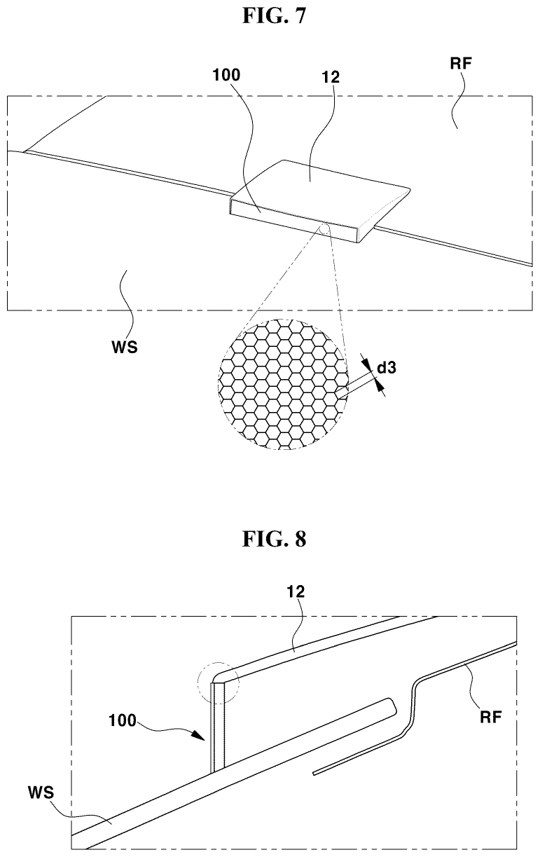

As illustrated in FIGS. 7 and 8, the cover 100 may define at least a portion of the housing 12 of the environment sensor 2. In the illustrated implementation, the housing of the lidar sensor is placed over the roof (RF) and windshield (WS) of the vehicle. The cover 100, including the surface layer 140, may be mounted to the housing 12.

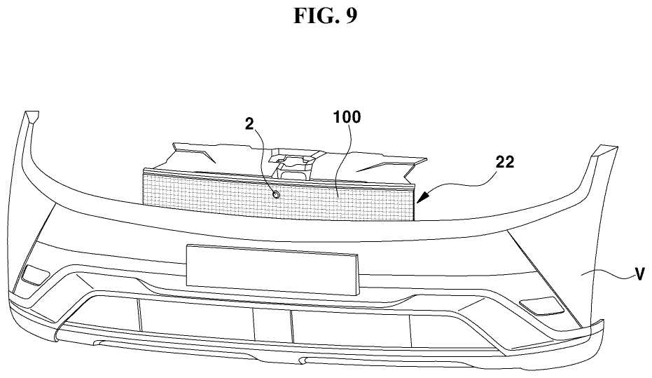

As illustrated in FIG. 9, the cover 100 may define at least a portion of the covering 22 of the environment sensor 2. As in the illustrated example, a surface-treated cover 100 may be placed on the covering 22 of the camera 2 placed at the front of the vehicle V. The cover 100 including the pattern 160 may be placed to cover the covering 22 while being spaced apart from the covering 22. In some implementations, the cover 100 including the pattern 160 may be attached on the covering 22.

The cover 100 according to the present disclosure may minimize or quickly remove foreign substances, such as water droplets, that affect the recognition performance of the environment sensor 2, such as a camera or a lidar sensor, without affecting the recognition performance of the environment sensor 2. A coating method in which a pattern is formed by applying a metal coat to a glass or plastic surface and then peeling off the metal coat using a laser has been introduced. The coating method poses problems of light reflection or being recognized by an environment sensor, such as a camera, but the cover according to the present disclosure may avoid these problems. The cover according to the present disclosure includes a pattern formed through injection molding, increasing the dimensional stability of the pattern and allowing the thickness of the pattern to be adjustable.

The cover 100 is described herein as being applied to the vehicle V. However, the cover 100 may be applied not only to the vehicle V but also to other objects requiring a water-repellent function.

The cover having the water-repellent function according to the present disclosure may implement a thickness more than 10 times that of a conventional coat or film by using the surface layer made of PU, and thus may be protective against damage caused by collision or chipping and may be self-healed.

The cover according to the present disclosure may include a pattern integrated with the surface layer. Because the pattern may be formed using a mold, productivity may be increased.

According to the present disclosure, PU reaction injection molding has the advantage of enabling fine pattern printing. The properties of PU before injection molding are similar to water, and fine patterns may be formed through reactive molding using a hardener.

The cover according to the present disclosure enables efficient removal of water droplets without having to use electric or mechanical devices.

The cover according to the present disclosure has excellent durability and reliability because the cover is surface-treated with PU and is capable of self-healing.

As is apparent from the above description, the present disclosure provides the following effects.

According to the present disclosure, provided is a water-repellent cover configured to minimize the formation of droplets of foreign substances, such as moisture, on the surface thereof while overcoming the weaknesses of existing technology.

According to the present disclosure, provided is a water-repellent cover configured to easily remove moisture from the surface thereof while overcoming the weaknesses of existing technology.

Effects of the present disclosure are not limited to what has been described above, and other effects not mentioned herein will be clearly recognized by those skilled in the art based on the above description.

It will be apparent to those of ordinary skill in the art to which the present disclosure pertains that the present disclosure described above is not limited by the above-described embodiments and the accompanying drawings, and various substitutions, modifications and changes are possible within a range that does not depart from the technical idea of the present disclosure.

1. A cover comprising:
a surface layer comprising a pattern arranged in a predetermined shape on a surface of the surface layer,
wherein the pattern is made of a material same as that of the surface layer and is integrated with the surface layer.

2. The cover of claim 1, wherein the pattern protrudes from the surface layer.

3. The cover of claim 1, wherein a protrusion height of the pattern is within a range of 0.01 to 0.02 millimeters.

4. The cover of claim 1, wherein the pattern has a predetermined length and thickness, and wherein
the predetermined length is in a range of 0.2 to 0.3 millimeters, and
the predetermined thickness is in a range of 0.01 to 0.02 millimeters.

5. The cover of claim 1, wherein the pattern is arranged in a regular shape on the surface layer.

6. The cover of claim 1, wherein the pattern includes a hexagonal shape.

7. The cover of claim 1, wherein the surface layer and the pattern are integrated with each other through injection molding.

8. The cover of claim 1, wherein the surface layer is made of polyurethane.

9. The cover of claim 8, further comprising a base layer integrated with the surface layer and made of a polycarbonate material.

10. The cover of claim 9, wherein the surface layer and the base layer are integrated with each other through double-injection molding.

11. The cover of claim 9, further comprising a heating film disposed between the surface layer and the base layer.

12. The cover of claim 1, wherein the cover is placed on an object made of glass or plastic.

13. The cover of claim 1, wherein the cover is arranged to cover at least a portion of an environment sensor or a mirror.

14. A vehicle comprising the cover of claim 1.

15. A cover, comprising:
a first layer comprising a top surface and a bottom surface;
a second layer integrated with the bottom surface of the first layer; and
a pattern formed on the top surface of the first layer;
wherein the pattern comprises a material that is the same as that of the first layer and is integrated with the surface layer.

16. The cover of claim 15, wherein the pattern protrudes from the top surface of the first layer.

17. The cover of claim 15, further comprising a heating film disposed between the first layer and the second layer.

18. The cover of claim 15, wherein the pattern has a predetermined length and thickness, and wherein:
the predetermined length is in a range of 0.2 to 0.3 millimeters, and
the predetermined thickness is in a range of 0.01 to 0.02 millimeters.

19. The cover of claim 15, wherein the pattern comprises a hexagonal shape.

20. The cover of claim 19, wherein the hexagonal shape is repeatedly formed on the first surface.
